(19) United States
(12) Patent Application Publication
(10) Pub. No.: US 2017/0361327 A1
(43) Pub. Date: Dec. 21, 2017

(54) EASY-REPLENISHING DOUBLE-MATERIAL GRINDER

(71) Applicant: NINGBO CHEFSHERE KITCHEN TECHNOLOGY CO., LTD., Ningbo (CN)

(72) Inventor: GUOPING ZHANG, NINGBO (CN)

(21) Appl. No.: 15/693,479

(22) Filed: Sep. 1, 2017

Related U.S. Application Data
(63) Continuation of application No. PCT/CN2015/078278, filed on May 5, 2015.

(30) Foreign Application Priority Data
Apr. 9, 2015 (CN) 201520212104.9

(51) Int. Cl. B02C 7/16; A47J 43/25; B02C 7/12; B02C 21/02

(52) U.S. Cl. CPC B02C 7/16; B02C 21/02; A47J 43/25; B02C 7/12

(57) ABSTRACT

The present disclosure discloses a double-material grinder for grinding materials comprising a housing and a grinding component. The housing comprises a first housing and a second housing removably attached to each other to form a closed cavity. The first housing comprises a vertical baffle. The grinding component comprises a first grinding unit arranged in the first chamber and a second grinding unit arranged in the second chamber. A blanking gap of the first grinding unit corresponds to the first blanking hole. A blanking gap of the second grinding unit corresponds to the second blanking hole. The second housing comprises a driving unit to drive the first grinding unit and the second grinding unit. The mouth for adding materials is open and substantially larger than those of other two-material grinders so that replenishing of materials becomes easier and mixture of different materials is completely prevented.

### CROSS-REFERENCE TO RELATED APPLICATIONS

This application is a continuation of International Patent Application No. PCT/CN2015/078278 with a filing date of May. 5, 2015, designating the United States, now pending, and further claims priority to Chinese Patent Application No. 201520212104.9 with a filing date of Apr. 9, 2015. The content of the aforementioned applications, including any intervening amendments thereto, are incorporated herein by reference.

### TECHNICAL FIELD

The present disclosure relates to a domestic grinder, and more particularly, to a easy-replenishing double-material grinder.

### BACKGROUND OF THE PRESENT INVENTION

Domestic grinders to grind ingredients are widely used in families for purposes of improving quality of food and freshness of food materials. Domestic grinders in prior arts usually comprise only one vessel to place one kind of material. If several kinds of materials are to be grinded, a user would need to prepare multiple grinders which occupy more space.

Therefore, a kind of grinders to grind multiple materials at the same time has been developed. This kind of grinders comprises on vessel with a baffle deployed within to divide the vessel into a few separated cavities. Each cavity is used to store one kind of material. Materials stored in all cavities are grinded with the same set of grinding heads. Because the materials are usually grinded into small particles or powder, the grinded particles or powder may be residual on the grinding heads. The residual materials would be mixed with other materials when the grinding heads are switched to grind other materials and affect flavor of prepared foods. Materials are added into the cavities through one relatively small opening which makes it inconvenient to add materials. It is also likely one material is added to cavities for other materials and mix with different materials.

### SUMMARY OF PRESENT INVENTION

One objective of the present disclosure is to alleviate some problems of the prior arts by providing a double-material grinder which facilitates replenishing of materials.

The present disclosure discloses a double-material grinder for grinding materials comprising a housing and a grinding component having a male grinding head and a female grinding head. The housing comprises a first housing and a second housing removably attached to each other to form a closed cavity. The first housing comprises a vertical baffle to divide the first housing into a first chamber and a second chamber. The first housing comprises a first blanking hole and a second blanking hole corresponding to the first chamber and the second chamber respectively on the bottom of the first housing. The grinding component comprises a first grinding unit arranged in the first chamber and a second grinding unit arranged in the second chamber. A blanking gap of the first grinding unit corresponds to the first blanking hole. A blanking gap of the second grinding unit corresponds to the second blanking hole. The second housing comprises a driving unit to drive the first grinding unit and the second grinding unit.

In some embodiments, the first housing further comprises a lateral baffle to divide each of the first and second chambers into an upper part and a lower part to facilitate reservation of materials. The first grinding unit and the second grinding unit are arranged in respective lower parts, the upper parts are formed as a first storage for a first material and a second storage for a second material. The lateral baffle comprises a first blanking aperture corresponding to the first grinding unit and a second blanking aperture corresponding to the second grinding unit.

In some embodiments, the first housing is shaped as a truncated cone or a truncated ellipsoid.

In some embodiments, the first housing and the second housing are connected by a bayonet connection to facilitate mounting and detaching of the first and second housings. The bayonet connection can be implemented in any kind of prior arts such as a matching configuration of a fitting slot and a fitting block.

In some embodiments, the first housing and the second housing are connected by a threaded connection.

The grinder of the present disclosure comprises an open mouth for adding materials compared to prior arts. The mouth for adding materials is substantially larger than those of other two-material grinders so that replenishing of materials becomes easier and mixture of different materials is completely prevented. Space for the storages as disclosed can be reserved in the grinder according to the concise and compact design of the grinder.

### DESCRIPTION OF THE DRAWINGS

FIG. 1 is a schematic drawing of an assembled grinder according to an embodiment.

FIG. 2 is a schematic drawing of a disassembled grinder during replenishing of materials according to an embodiment.

FIG. 3 is a schematic perspective view of a first housing 11 and the grinding components within according to an embodiment.

### DETAILED DESCRIPTION OF PREFERRED EMBODIMENTS

Exemplary embodiments of the present disclosure are described in greater detail below in connection with the figures.

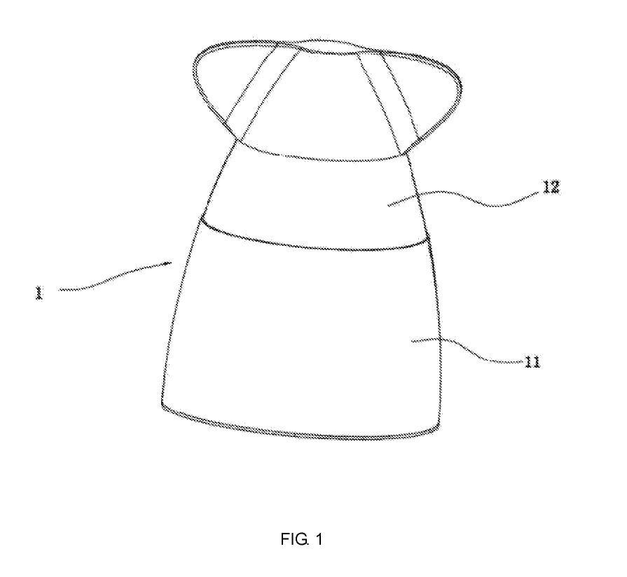

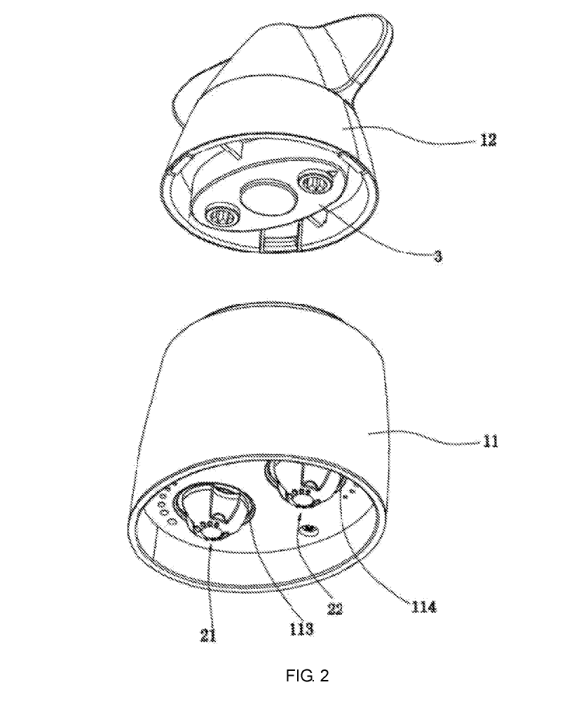

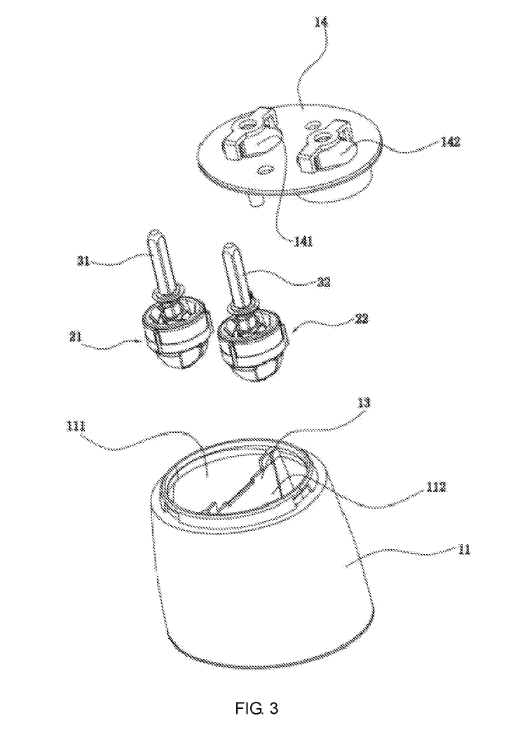

As shown in FIG. 1-3, an easy-replenishing double-material grinder comprises a first housing 11 and a second housing 12 which are attached to each other to form respective closed cavities to mount various components. The first and second housings in an embodiment are connected by a conventional bayonet structure or threaded connection. The first housing is shaped as a truncated ellipsoid to provide a larger mouth which avoids mixture of materials.

The second housing 12 comprises a driving unit 3 to drive a first grinding unit 21 and a second grinding unit 22 respectively. The driving unit 3 is drivably connected to a male grinding head of the first grinding unit and a male grinding head of the second grinding unit by a first connecting bar 31 and a second connecting bar 32, respectively.

The driving unit 3 can be implemented in any conventional technology according to demands. For example, the driving device for combined grinders as disclosed in ZL201220681248.5 or ZL201420037729.1 can be employed.

The first housing 11 comprises a vertical baffle 13 to divide the first housing 11 into a first chamber and a second chamber. The first housing 11 further comprises a lateral baffle 14 to divide each of the first and second chambers into an upper part and a lower part. The first and second chambers are separated by the vertical baffle 13 at the lower parts where the first grinding unit 21 and the second grinding unit 22 are mounted respectively. The upper parts of the two chambers are separated by the vertical baffle to form a first storage 111 for a first material to be grinded and a second storage 112 for a second material to be grinded.

The lateral baffle 14 comprises a first blanking aperture 141 corresponding to the first grinding unit 21 and a second blanking aperture 142 corresponding to the second grinding unit 22.

The first housing 11 comprises a first blanking hole 113 and a second blanking hole 114 with a distance between the two holes. A blanking gap of the first grinding unit corresponds to the first blanking hole 113. A blanking gap of the second grinding unit corresponds to the second blanking hole 114.

The grinding component of the embodiments comprises female grinding heads and male grinding heads set within the female grinding heads, which both pertain to prior arts.

When it is need to replenish materials, the second housing along with the driving unit are detached from the first housing before replenishing of materials into the first storage and/or the second storage. Since the mouth is large in size and completely open, replenishing of materials is easier and mixture of different materials is avoided. After materials have been replenished, the second housing along with the driving unit are mounted onto the first housing again.

During grinding, the driving unit can be operated to drive the first grinding unit or the second grinding unit. Materials in the first storage enter a gap of the first grinding unit through the first blanking aperture, and leak from the first blanking hole for use. The process is similar for the second grinding unit.

I claim:

1. A double-material grinder for grinding materials, comprising:
a housing (1); and
a grinding component having a male grinding head and a female grinding head, wherein the housing (1) comprises a first housing (11) and a second housing (12) removably attached to each other to form a closed cavity,
the first housing (11) comprises a vertical baffle (13) to divide the first housing (11) into a first chamber and a second chamber,
the first housing (11) comprises a first blanking hole (113) and a second blanking hole (114) corresponding to the first chamber and the second chamber respectively on the bottom of the first housing,
the grinding component comprises a first grinding unit (21) arranged in the first chamber and a second grinding unit (22) arranged in the second chamber,
a blanking gap of the first grinding unit (21) corresponds to the first blanking hole (113),
a blanking gap of the second grinding unit (22) corresponds to the second blanking hole (114), and
the second housing (12) comprises a driving unit (3) to drive the first grinding unit (21) and the second grinding unit (22).

2. The grinder of claim 1, wherein the first housing (11) further comprises a lateral baffle (14) to divide each of the first and second chambers into an upper part and a lower part, the first grinding unit (21) and the second grinding unit (22) are arranged in respective lower parts, the upper parts are formed as a first storage (111) for a first material and a second storage (112) for a second material, and the lateral baffle (14) comprises a first blanking aperture (141) corresponding to the first grinding unit (21) and a second blanking aperture (142) corresponding to the second grinding unit(22).

3. The grinder of claim 1, wherein the first housing (11) is shaped as a truncated cone or a truncated ellipsoid.

4. The grinder of claim 3, wherein the first housing (11) and the second housing (12) are connected by a bayonet connection.

5. The grinder of claim 3, wherein the first housing (11) and the second housing (12) are connected by a threaded connection.
